(19) United States
(12) Patent Application Publication
(10) Pub. No.: US 2009/0271563 A1
(43) Pub. Date: Oct. 29, 2009

(54) FLASH MEMORY TRANSACTIONING

(75) Inventors: Yadhu N. Gopalan, Redmond, WA (US); William J. Westerinen, Sammamish, WA (US); James R. Hamilton, Bellevue, WA (US); John Mark Miller, Kirkland, WA (US); Vladimir Sadovsky, Redmond, WA (US); Robert Patrick Fitzgerald, Fall City, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/110,574

(22) Filed: Apr. 28, 2008

(51) Int. Cl. G06F 12/02

(52) U.S. Cl. 711/103; 711/E12.008

(57) ABSTRACT

Providing for improved transactioning for Flash memory is described herein. By way of example, transactioning operations associated with abstract data structures can be bundled into a common layer of a Flash management protocol stack, to reduce transaction redundancy at abstracted layers. In some aspects, the common layer can be a block level layer providing relatively direct access to low level Flash. Thus, a file system or database application, operating at a higher, abstracted layer of the Flash management protocol stack, can offload transactioning operations to a block level process that has access to underlying Flash memory. As a result, increased efficiency, throughput, and added flexibility can be achieved for storage system transactioning.

### BACKGROUND

Non-volatile memory, in various forms, provides remarkable benefits for storage and management of electronic information. One example is the ability for non-volatile memory to retain stored data when not electrically powered. Accordingly, stored data can be transported without need of continuous connection to a power source, such as a battery. Furthermore, electrical power can be conserved when utilizing non-volatile memory to store data, for instance, by simply shutting off power to a device when processing components or other system components are idle.

Some examples of non-volatile memory can include mechanically addressed non-volatile memory, such as hard disks, optical discs, magnetic tape, holographic memory, etc., and electrically addressed non-volatile memory, such as Flash memory (e.g., NOR gate Flash, NAND gate Flash, electrically erasable read only memory [EAROM], electrically programmable read only memory [EPROM], electrically erasable programmable read only memory [EEPROM], etc.). Of particular utility is Flash memory due to its flexibility as an onboard or stand-alone portable storage device, and its speed in accessing (e.g., reading, writing) memory cells. For instance, Flash memory is commonly used in small, portable universal serial bus (USB) devices, as well as buffer or cache memory for processing components or hard disks and even as system random access memory (RAM).

One reason for versatility of Flash memory is processor compatibility. Flash memory can comprise raw memory that is controlled by a host device processor (e.g., a central processing unit [CPU] of a personal computer), by an onboard microcontroller, or both. Such a processor(s) can typically perform read, write and erase operations, as well as Flash transactioning applications such as data logging, data rollback, cell wear leveling and cell error management.

Typically, an onboard microcontroller is provided with a set of instructions when manufactured to perform transactioning operations. In some cases, where an application executed on both a Flash microcontroller and a host CPU incorporates such operations, instructions (e.g., device drivers) can be provided from one processor to the other to facilitate shared processing. Thus, a database managed by a host CPU can perform data error management and update, modify, copy, etc., data stored in Flash memory utilizing device drivers provided by a Flash device. By employing shared processing, a host device can provide various levels of data abstraction, exemplified by an SQL database for instance, in conjunction with underlying Flash memory.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject disclosure provides for bundling transactioning operations that manage Flash memory data onto a single layer of a Flash management protocol stack. In addition, the single layer can be a block layer that manages raw Flash. Thus, a file system or database application, operating at a higher, abstracted layer of the Flash management protocol stack, can offload transactioning operations to a block level process that has access to underlying memory blocks of a Flash memory device. Accordingly, modifications to handling of raw Flash can be implemented in conjunction with such transactioning operations.

According to one or more other aspects of the subject disclosure, applications that deal with Flash memory can be consolidated at a single device processor. For instance, an abstracted storage system such as a database (e.g., a SQL server) and raw Flash management processes can be executed at either a host processor or an onboard Flash microcontroller. Accordingly, some inefficiency that results from shared processing between a host CPU and the onboard microcontroller can be mitigated or avoided.

According to one or more other aspects of the subject disclosure, an abstracted storage system operating at higher levels of a memory protocol stack can manage transactioning operations bundled at a lower layer. A memory interface can facilitate exchange of data and/or commands from upper layer applications and lower layer applications. Thus, a database or file system can manage the operation of raw memory in a convention suited to the database, whereas a transactioning process can implement the raw memory operation in a convention suited to a block layer application. Accordingly, by interacting with memory components in a manner specifically suited for a process operating at a particular protocol stack layer, such processes can run more efficiently.

In accordance with at least one additional aspect, a system is provided that improves management of raw memory of a Flash device for memory-related applications of a host device. Data transactioning applications, including data logging, error tracking, wear-leveling, data rollback, or the like, are implemented at a block layer of a Flash memory protocol stack. Storage system applications, such as a file system or database, are implemented at higher, abstracted layers of the protocol stack. Furthermore, applications at each layer can be executed at a common processor, such as a CPU of the host device, or a microcontroller of the Flash device. In at least one aspect, memory-related processes can be transferred to the CPU or the microcontroller based on characteristics of the processes, an application, or of the memory. Accordingly, additional flexibility is provided by bundling like processes at one or more layers of the protocol stack and implementing the processes at a common processor.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 depicts a block diagram of an example system that bundles like memory-related processes at common layers of a memory protocol stack.

FIG. 2 illustrates a block diagram of a sample Flash management protocol stack that bundles data transactioning at a block level of the stack.

FIG. 3 depicts a block diagram of a sample system that provides block level transactioning for abstracted data structures according to aspects disclosed herein.

FIG. 4 illustrates a block diagram of an example system that provides improved rollback functionality for Flash memory according to one or more aspects.

FIG. 5 depicts a block diagram of a sample system that provides block level data tracking and encryption for Flash memory.

FIG. 6 illustrates a block diagram of an example system that provides block level control of Flash transactioning for abstracted data structures.

FIG. 7 depicts a flowchart of an example methodology for bundling Flash related transactioning at a common protocol layer according to aspects of the disclosure.

FIG. 8 illustrates a flowchart of a sample methodology for providing improved rollback functionality for Flash memory.

FIG. 9 depicts a flowchart of an example methodology for monitoring block level Flash transactions in conjunction with an abstracted storage system.

FIG. 10 illustrates a block diagram of a sample operating environment that implements Flash memory transactioning for abstract data structures.

FIG. 11 depicts a block diagram of an example network communication environment that provides remote communication between electronic devices.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, “engine”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component can be localized on one computer and/or distributed between two or more computers. As another example, an interface can include I/O components as well as associated processor, application, and/or API components, and can be as simple as a command line or a more complex Integrated Development Environment (IDE).

The subject disclosure provides for bundling transactioning operations associated with Flash memory data storage (e.g., NAND FLASH, NOR FLASH, and so on, hereinafter referred to as Flash) onto a common layer of a Flash management protocol stack. The common layer can be a block level layer that relates to management of raw Flash memory. Accordingly, higher level abstracted data structures based on the underlying Flash memory, such as a file system, database, or the like, can control management of raw Flash blocks in conjunction with the transactioning operations.

Flash memory and other electrically addressed solid state storage devices were constructed as alternatives to mechanically addressed disc and tape storage devices (e.g., tape drive, hard drive, compact disc [CD] drive, digital versatile disc [DVD] drive). Operation and management of mechanically addressed storage involves inherent latency that results from mechanical manipulation of an underlying storage medium. For instance, CD and DVD data access times are dependent on a rotation speed of the storage medium. Hard drives and tape drives involve similar data access limitations. Electrically addressed storage, on the other hand, is not limited by mechanical manipulation of storage media. For instance, data access times for Flash memory approach propagation speeds of electric signals in the storage device. This is because addressing and data access are performed utilizing electronic logic, rather than electro-mechanical mechanisms.

Despite inherent differences in disc storage and Flash memory, Flash memory management is typically patterned after disc storage management. One reason is that disc storage predates Flash memory. Thus, by recycling management architectures designed to control or represent disc memory for Flash memory, initial design time and cost can be reduced. As an example, although Flash memory is not directly overwritten, unlike disc memory, Flash data management provided to external applications often include rewrite commands. The underlying manipulation of raw data cells required to implement rewrite is different for Flash as compared with disc storage, but an application might not see this difference. Typically, the application does not have direct control over the rewrite process either, so the process may not adapted or optimized to suit particular demands of the application. Thus, although recycling disc storage architectures for Flash have proven useful, advantages of Flash memory have not been fully incorporated across modern operating systems as a result.

By bundling transactioning applications, such as memory logging, data rollback, error tracking, wear-leveling and/or the like, onto a common layer of a Flash management protocol stack, other Flash capabilities performed at such a layer can be incorporated into transactioning. For instance, a block layer typically manages addressing, reading, writing, erasing and like operations of raw Flash cells/cell blocks. Thus by bundling transactioning at the block layer, block layer management can be incorporated into Flash transactioning. In addition, other processes operating at abstracted layers of the Flash protocol stack can run more efficiently if transactioning is not performed at those layers. The abstracted layers can be rewritten to focus more pointedly on abstracted data systems (e.g., file systems, database systems, etc.) and to interact with other protocol layers in conjunction with data transactioning. Accordingly, the subject disclosure provides for a more efficient and more capable implementation of Flash transactioning and Flash-related applications, less limited by legacy storage architectures suited more to disc storage than to Flash storage.

It should be appreciated that, as described herein, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . optical disks (e.g., compact disk (CD), digital versatile disk (DVD) . . . ), smart cards, and Flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). The aforementioned carrier wave, in conjunction with transmission or reception hardware and/or software, can also provide control of a computer to implement the disclosed subject matter. Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the amended claims, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

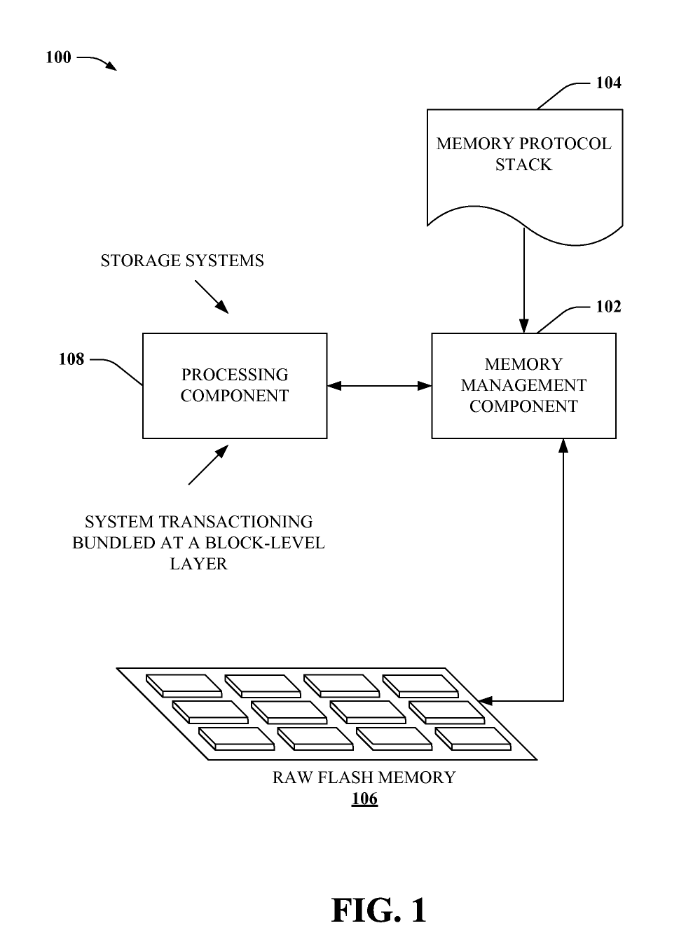

Referring now to the drawings, FIG. 1 depicts a block diagram of an example system 100 that bundles like memory-related processes at common layers of a memory protocol stack 104. Specifically, abstracted storage systems such as file systems, databases, and the like can be bundled at one or more higher levels of the protocol stack 104 whereas transactioning processes can be bundled at a block layer of the protocol stack 104. Accordingly, transactioning can incorporate block-level control of raw Flash 106. In addition, an abstracted storage system can operate with fewer limitations that result from implementing the storage system with related transactioning at a single protocol layer.

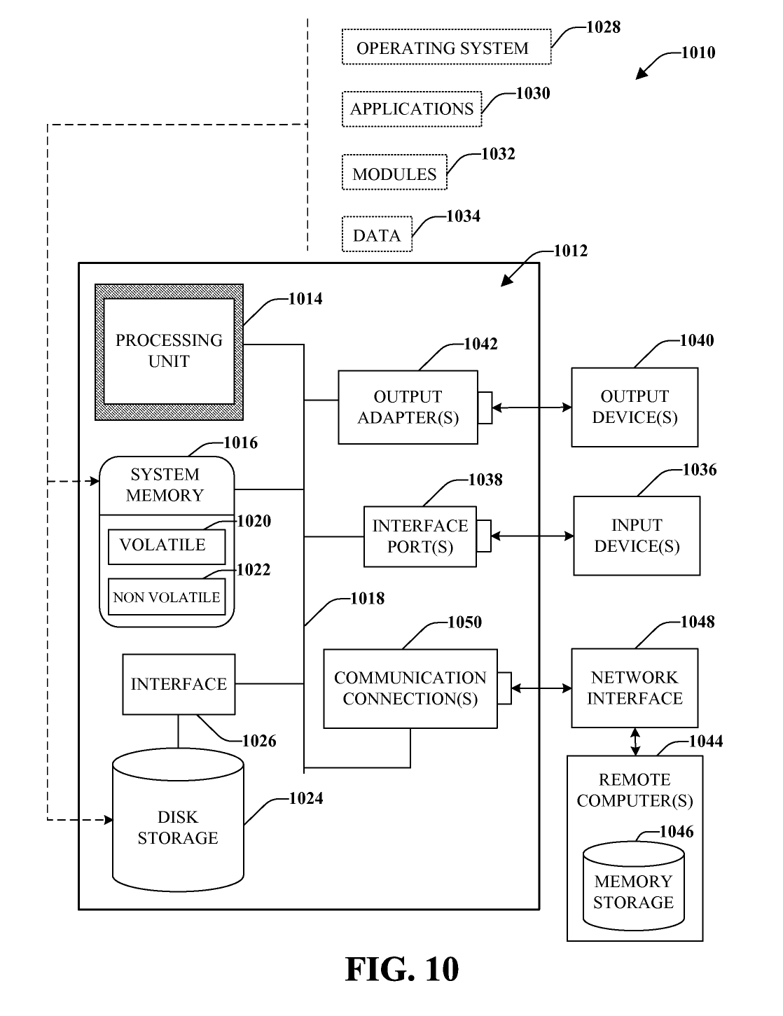

System 100 can include a memory management component 102 that interacts with blocks of raw Flash memory 106. Interaction can comprise block addressing in conjunction with reading, writing and/or erasing data from blocks of memory (106), copying data from one or more first blocks to one or more second blocks in conjunction with overwrite operations or re-write operations, and the like. In at least some aspects, memory management component 102 can employ a Flash management protocol stack 104 to manage the Flash memory 106. The Flash management protocol stack 104 can comprise two or more layers that can be executable at one or more processors (108). In at least one aspect of the subject disclosure, each layer of the Flash management protocol stack 104 is configured to be implemented at a single processor, which can include a central processing unit (CPU) of a host device, a microcontroller of a Flash memory chip, or other suitable processing device (e.g., see FIG. 10, infra).

System 100 includes a processing component 108 that can employ at least one processor to execute a storage system and a transactioning operation. The storage system can comprise any suitable abstracted form of block-level Flash memory. Examples can include a file system implemented on an operating system layer of the memory protocol stack 104, a database implemented on an application layer of the memory protocol stack 104, or a combination thereof or of like storage systems and/or protocol stack layers. It should be appreciated that the storage system can be configured to operate on a single processor (e.g., CPU, microcontroller, etc.) or be distributed across multiple processors.

Transactioning operations executed at processing component 108 can comprise error tracking functions (e.g., charge/data loss, charge refresh, data indexing, and/or the like), data rollback functions, data logging functions, wear-leveling functions and/or like functions pertinent to raw Flash memory 106. Typical transactioning can be performed at various protocol stack layers for various storage systems simultaneously (e.g., a processor may conduct transactioning for a file system at an operating system layer simultaneous with other transactioning for a database at an application layer). In at least one aspect of the disclosure, transactioning is conducted solely at one or more layers of the Flash memory protocol stack 104 dedicated for management of raw Flash 106. In some such aspects, the one or more layers can comprise a block-level layer. Further, such transactioning can serve multiple data storage systems operating at various other layers of the Flash memory protocol stack 104. Thus, system 100 segregates transactioning operations from storage system operations in the memory protocol stack 104.

In addition to the foregoing, it should be appreciated that processing component 108 can implement transactioning at a block-level layer of the protocol stack 104 simultaneous with storage systems implemented at higher, abstracted layers of the protocol stack 104. Furthermore, it should be appreciated that in at least one aspect processing component can bundle storage system and transactioning onto a single processor (e.g., a CPU, one or more cores of a multi-core chip, a Flash microcontroller, etc.). Thus, in such aspects a host processing device coupled with Flash memory 106 (e.g., a universal serial bus [USB] Flash stick) can implement the storage system as well as system transactioning, where the transactioning manipulates operation of raw Flash memory 106.

It should be appreciated that raw Flash memory 106 can comprise any suitable type of Flash memory. Specific examples of Flash memory can include NOR gate Flash, NAND gate Flash, or the like. Other general examples can include electrically erasable read only memory (EAROM), electrically programmable read only memory (EPROM), electrically erasable programmable read only memory (EEPROM), and so on.

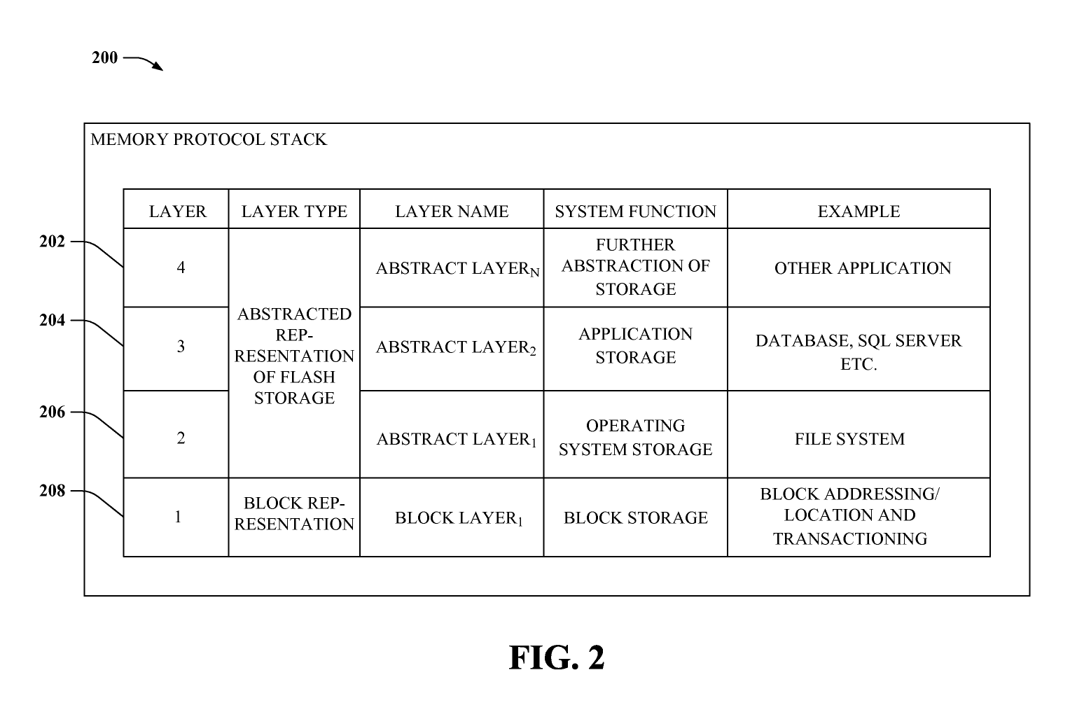

FIG. 2 illustrates a block diagram of a sample Flash management protocol stack 200 that bundles data transactioning at a block level of the stack 200. Flash management protocol stack 200 can be employed by a suitable processing environment and/or a suitable controlled Flash memory module as described herein. Specifically, the protocol stack 200 comprises at least two layers (202, 204, 206, 208) that provide instructions for controlling raw Flash memory and implementing abstracted data structures based on the underlying Flash memory. In general, the protocol stack 200 can provide improved efficiency and functionality related to Flash-related applications and Flash management by segregating raw Flash management and abstracted Flash-related applications on separate layers of the protocol stack 200.

Flash management protocol stack 200 comprises multiple protocol layers for managing Flash-related processes. The protocol layers comprise at least one block-level layer 208 and one or more higher level abstracted layers 202, 204, 206. The higher level abstracted layers can comprise instructions suited to generate an abstracted representation of raw storage cells of Flash memory. Examples can include an operating system layer that can represent underlying Flash memory as a file system, an application layer that can represent the underlying Flash memory as a database, such as a structured query language (SQL) database, and/or like layers and representations of blocks of Flash memory. Processes implemented at the higher abstracted layers of the protocol stack 200 can be configured to exchange data with processes implemented at lower layers of the protocol stack (e.g., a block layer). Thus, abstracted data structures can manage transactioning implemented at a block-level layer(s).

In addition to higher level abstracted protocol layers, Flash management protocol stack 200 comprises at least one block-level layer that interfaces directly with raw Flash (e.g., see FIG. 1 at 106, supra). The block-level layer, therefore, can be configured to read, write, erase, address, etc., Flash memory cells and/or blocks of such cells. In addition, the block-level layers of Flash management protocol stack 200 can be configured for transactioning processes pertinent to one or more higher level data storage systems. Such transactioning can comprise error tracking, data rollback, data logging, wear-leveling, and/or the like as described herein or known in the art. Thus, transactioning processes can be coupled with, adapt to and/or modify raw Flash management processing.

As one example of the foregoing, a wear-leveling process could adjust read/write times to one or more blocks of raw Flash memory to speed up or slow down wear-leveling operations. In another example, a data rollback process can delay erasure of blocks of Flash scheduled for deletion. For instance, Flash re-write operations can copy data from blocks scheduled for re-write to ‘temporary’ blocks of memory. The blocks scheduled for re-write are then erased, and the data is copied form the ‘temporary’ blocks back to the erased blocks. However, a data rollback can take advantage of the temporary blocks or the blocks scheduled for re-write to fulfill a rollback request. Specifically, erasure of data either from the re-write scheduled blocks or temporary blocks, or both, can be delayed a predetermined period of time. If a rollback request is received, a data pointer associated with the requested data can be associated with the delayed blocks. Data in such blocks can be read and provided to fulfill the request. Accordingly, logging operations which store erased data in temporary memory and/or track movement of ‘erased’ data can be reduced as a result of improved rollback.

By separating transactioning processes from data storage processes within the protocol stack 200, such processes can be implemented more efficiently. Further, by utilizing a block level layer for transactioning, as described herein, increased control of raw Flash can be provided for such operations. Thus, storage system transactioning can be implemented in an improved manner utilizing the Flash management protocol stack 200 described above.

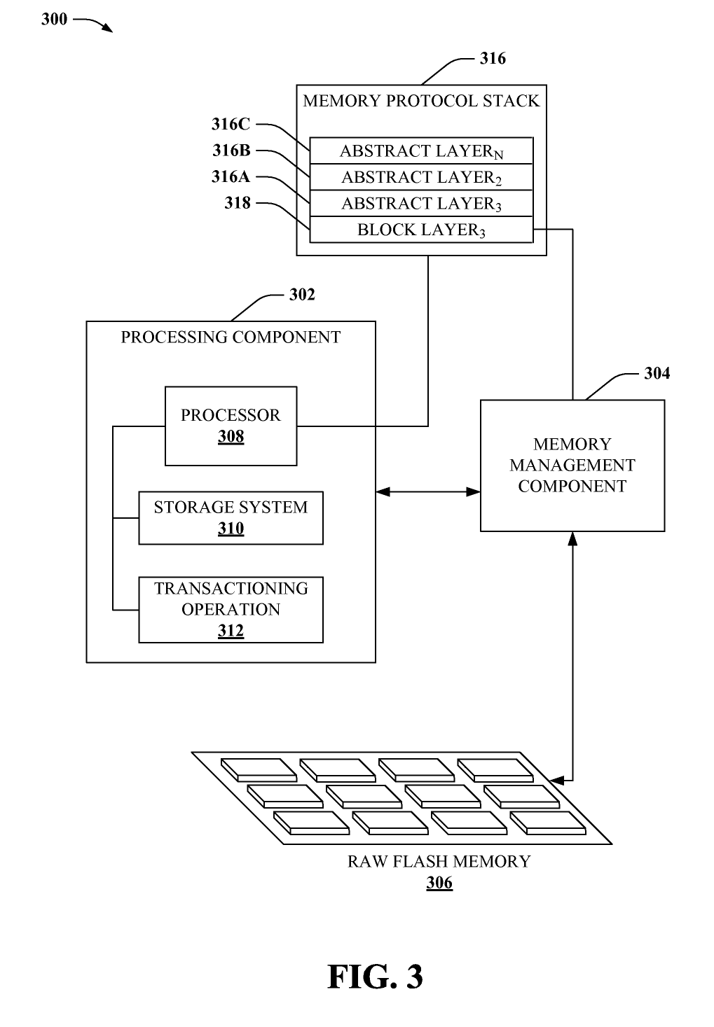

FIG. 3 depicts a block diagram of a sample system 300 that provides block level transactioning for abstracted data structures according to aspects disclosed herein. Processing for system 300 can be executed by one or more processors, such as a device CPU or Flash microcontroller. In some aspects, processes can be combined onto a single such processor or processor core, reducing latency involved in shared processing. In addition, because transactioning is performed at a block layer, data structure applications can take advantage of increased control of raw Flash for such transactioning, and can further operate more efficiently on abstracted layers of protocol stack (316). Accordingly, system 300 can provide significant benefits for Flash memory-related applications and processing.

System 300 comprises a processing component 302 coupled with a memory management component 304. The processing component comprises one or more data processors 308. Further, the processing component 302 can be configured to implement Flash memory-related processes (310, 312) based on a Flash memory protocol stack 316. Specifically, processing component 302 can implement a storage system, such as a file structure of an operating system or an application database, at abstracted layers 316A, 316B, 316C of the protocol stack 316. Transactioning operations 312, as described herein, can be implemented at block level layers 318 of the protocol stack 318.

The memory management component 304 provides the processing component 302 with an interface to the raw Flash. The management component 304 can comprise a Flash microcontroller, in some instances (e.g., where processor 308 comprises a host device CPU) and/or an electrical bus and voltage source structure for electrically communicating with blocks of Flash memory 306 and storing data (e.g., charge) in other instances. In general, transactioning operations 312 can employ the memory management component 304 to interface directly with raw Flash cells/blocks of cells 306. As depicted, system 300 provides an improvement over traditional Flash memory architectures. By conducting transactioning at a block layer of the protocol stack, separate from abstracted layers 316A, 316B, 316C that provide system level or application level data management, transactioning can be consolidated and implemented more efficiently. Further, the block level layer enables the data management applications to exercise greater control over raw Flash, as described herein.

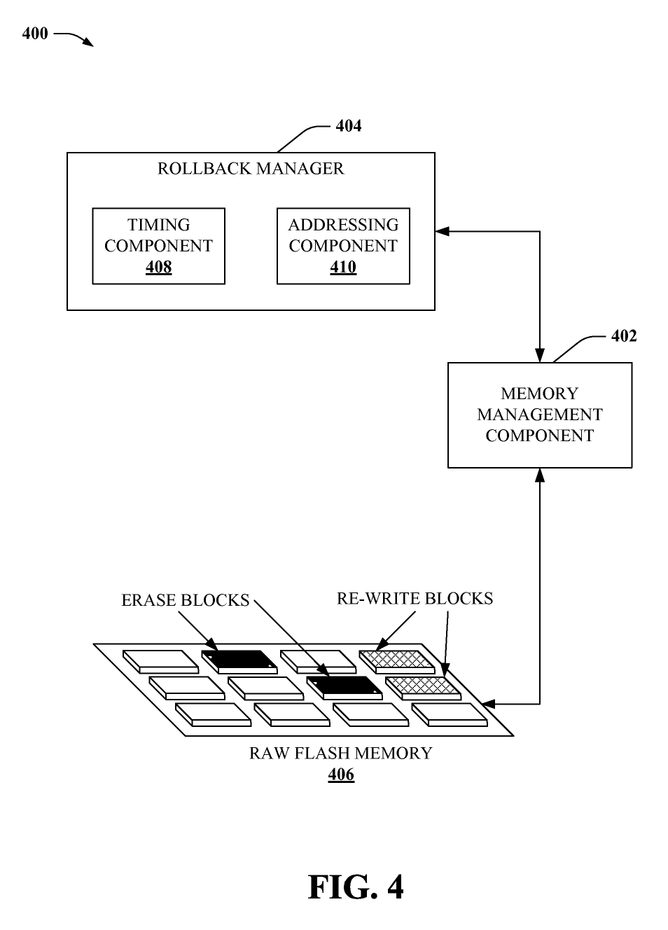

FIG. 4 illustrates a block diagram of an example system 400 that provides improved rollback functionality for Flash memory according to one or more aspects. System 400 can comprise a memory management component 402 that provides an interface to raw Flash memory 406 (e.g., see FIG. 3, supra). The management component 402 can further be coupled to a rollback manager 404. Rollback manager 404 can employ the management component 402 to interact with Flash memory. In some aspects, the rollback manager 404 can implement improved rollback functions for Flash memory-related applications, by taking advantage of transactioning conducted at a block layer of a Flash management protocol stack, as described herein.

Rollback manager can comprise a timing component 408. The timing component 408 can be employed to alter rates of typical Flash memory operations. Such operations can include block access times, such as reading or writing to blocks of memory, latencies associated with erasing data, copying data, re-write operations, and so on. In at least one aspect, timing component 408 can be employed to delay erasure of blocks of raw Flash scheduled for deletion. Such blocks can include, for instance, blocks erased in conjunction with re-writing data, temporary blocks that store data to facilitate re-write operations or wear-leveling, and so on. As a particular example, erasure of blocks can be delayed if requested by a storage system. For instance, where data has a predetermined likelihood of being refreshed within a period of time, erasure of blocks can be delayed an appropriate amount of time to facilitate rapid recovery of the data.

Rollback manager 404 can further comprise an addressing component 410 that can sets a data pointer associated with data, to one or more blocks of Flash memory storing such data. Accordingly, the data pointers can be utilized to locate data. In some aspects, the data pointer is utilized to facilitate re-write or wear-leveling operations that employ temporary blocks of memory. For instance, where data from a first block of memory is moved to a temporary block in conjunction with re-writing the first block, a data pointer associated with the moved data can be set to the temporary blocks of data. Thus, by referencing the pointer, a location of the moved data stored can be determined.

Rollback manager can utilize the addressing component 410 to shift a data pointer from one set of blocks to another. Thus, in one example where data is stored in blocks scheduled for deletion, a data pointer can be set to reference temporary blocks containing copied data. If a rollback request is received by the rollback manager, and the scheduled deletion has not occurred yet, the pointer can be set back to the original blocks to quickly retrieve the data. If the deletion has occurred, the pointer can be referenced and the data read from the temporary blocks to facilitate the rollback. Thus in at least one aspect, system 400 can reduce logging processes that track movement of data by replacing a portion of such processes with an improved rollback mechanism, freeing up system processor resources.

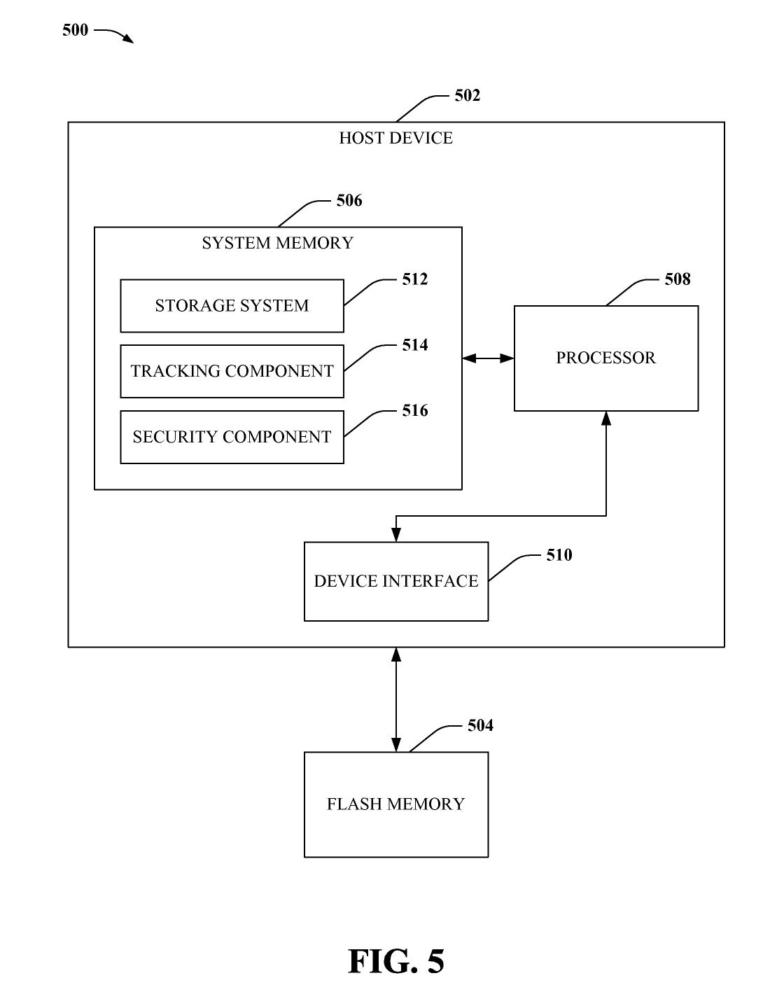

FIG. 5 depicts a block diagram of a sample system 500 that provides block level data tracking and encryption for Flash memory. Block level processes can be conducted at dedicated layers of a Flash memory protocol stack. In addition, non block layer processes can be segregated onto abstracted layers of the protocol stack. The data tracking and security can be implemented in conjunction with raw Flash operation and processes, provided increased flexibility and reliability according to some aspects.

A host device 502 can be coupled with Flash memory 504. The host device can be any suitable operating environment, such as a computer, laptop, mobile communication device, etc. (e.g., see FIG. 10, infra). Further, the Flash memory 504 can be a managed Flash device (e.g., comprising an onboard microcontroller) or raw, unmanaged Flash. The host device 502 and Flash memory 504 can be coupled by a suitable device interface 510, which can include a bus structure (e.g., USB), remote communication network, wireless communication network, ad-hoc wired and/or wireless communication, or the like.

System memory 506 of the host device can comprise one or more components (512, 514, 516) for implementing Flash memory-related applications. The memory can be coupled with a processor 508, such as a CPU, that executes the applications. Data is exchanged with the Flash memory 504 via the device interface. Such data can include commands, such as read/write/erase commands, commands utilized by Flash management applications such as transactioning applications, and so on, or data for storage, retrieval, or the like. Processor 508 can utilize a Flash memory protocol stack as described herein, that separates transactioning operations from abstracted data structures.

Flash memory-related components can include one or more storage systems 512. The storage systems can comprise abstracted representations of raw Flash memory, such as a file structure or database, or the like. The storage systems can be configured for abstracted layers of a Flash management protocol stack, and be segregated from transactioning applications implemented on a block layer of the protocol stack. Accordingly, the storage systems can be executed more efficiently by reducing processing requirements involved in redundant transactioning implemented for storage systems at each layer of the protocol stack.

System memory 506 can further include a tracking component 514. The tracking component can create an index of storage system operations associated with Flash memory at the block layer. Indexing can be utilized, for instance, in conjunction with error recovery, data filtering, content searching, and the like. For instance, tracking component 514 can manage and update an index based on data stored at the Flash memory device 504. Furthermore, by conducting the indexing at a block layer of a Flash management protocol stack, processor 508 can implement the index, faster, more accurately and in greater detail as compared with conventional systems. For instance, knowledge of data storage at a block level can be maintained at the index. Thus, searching and data filtering can be provided based on direct interaction with low level data storage 504. Such an arrangement can be exceptionally beneficial where bandwidth within the Flash memory 504 greatly exceeds bandwidth of the device interface 510. By conducting filtering and context searching at the block level, only data pertinent to a search is provided across the relatively slow device interface 510, increasing overall speed of the host device 502-Flash memory 504 interface.

In addition to the foregoing, system memory 506 can comprise a security component 516. Security component 516 can employ various algorithms for encrypting and/or decrypting data. Examples can include key algorithms, paired key algorithms, hash functions, and/or the like. Furthermore, the security can be implemented at a block level of the Flash memory. Specifically, where security component 516 is configured for a lower block-level layer of a Flash management protocol stack, the security component 516 ca interact direct with underlying raw Flash. Accordingly, security can be made more robust by limiting exposure at complex, abstracted applications of upper protocol layers (e.g., application layer).

In one specific example of the foregoing, security component 516 can implement secured transactions for data stored at Flash memory 504. For instance, by employing Flash transactioning applications implemented at a block layer, security component 516 can direct data written to blocks of the Flash memory 504 to be encrypted in conjunction with the writing. Thus, the raw data is stored in an encrypted form. Such encryption can employ any suitable algorithm or means for encrypting data stored at security component 516. In such aspects, additional security is provided as the data is encrypted as written and stored in raw memory. Such aspects are in contrast to less secure mechanisms that write data to raw Flash in non-encrypted form, and encrypt the data at a non-block layer (e.g., where data is written in non-encrypted form and an operating system or database encrypts the data only upon extracting it from the Flash blocks and providing it to an external entity). Accordingly, if the raw Flash blocks are accessed by an unauthorized entity, the data cannot be extracted in non-encrypted form.

As depicted, system 500 provides an interactive system whereby a host device can couple to Flash memory, and manage block level transactions for Flash-related data storage. Furthermore, by leveraging underlying capabilities of the Flash memory 504, improved throughput and/or security can be achieved. For instance, be offloading some Flash processing to the Flash memory 504, data searching and content filtering can be implemented that reduces the amount of data that passes over the interface 510, reducing data latency and increasing overall throughput and response times. Further, data can be encrypted as written at the block level, reducing the danger of unauthorized access to block-level Flash (504).

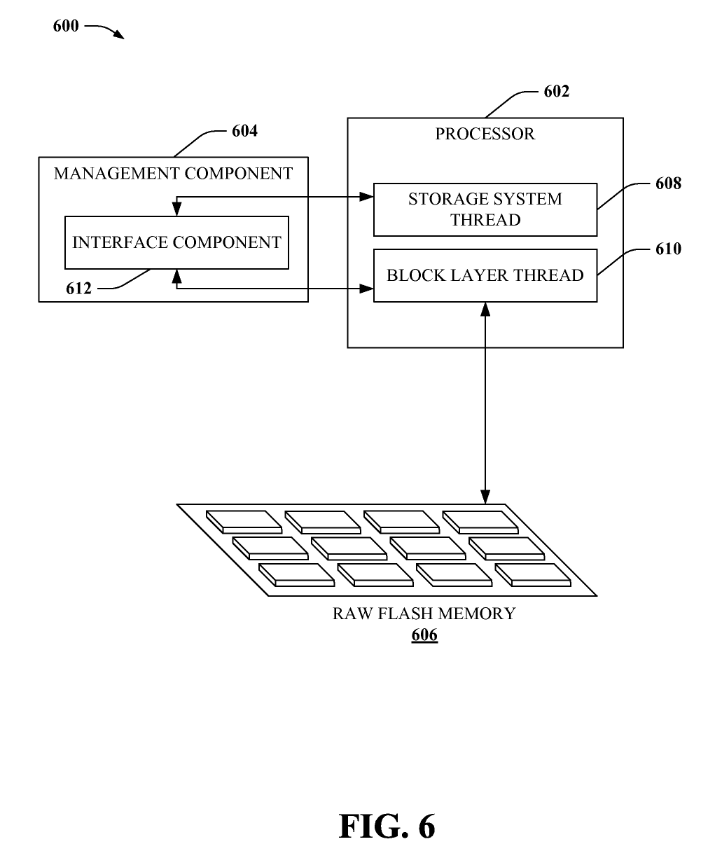

FIG. 6 illustrates a block diagram of an example system 600 that provides block level control of Flash transactioning for abstracted data structures. System 600 comprises a processor 602 that executes one or more process threads 608, 610 related to Flash memory. The processor can be a CPU of a host processing device coupled to Flash memory 606, or an onboard Flash microcontroller. The processor can implement process threads configured for various levels of a Flash management protocol stack. Moreover, the processor can segregate threads suited to abstracted representations of block level Flash from applications suited to block level Flash management. Accordingly, a storage system thread 608 related to a file system or database can be separated within a protocol stack from transactioning or other block level threads 610 implemented at a low level of the protocol stack.

System 600 further comprises a management component 604 that provides an interface (612) between higher level, abstracted applications 608 and block level applications 610. In some aspects, an interface component 612 can translate activity associated with the storage system 608 into commands or data that can be consumed by the transactioning operations 610 at the block layer. Such an arrangement enables abstracted applications such as the storage system 608 to execute in accordance with a first configuration and low level applications to execute in accordance with a second configuration. Thus, the storage system can achieve more flexible and powerful access to control of raw Flash operations by the interface (612) with the block layer applications (e.g., wear-leveling, data logging, error tracking, data indexing, data rollback, and the like). Furthermore, efficiency need not be sacrificed by redundant low level management performed at each of multiple abstracted layers of the protocol stack. Instead, such management is bundled with block layer threads 610 freeing up redundancy at the storage systems 608.

The aforementioned systems have been described with respect to interaction between several components. It should be appreciated that such systems and components can include those components or sub-components specified therein, some of the specified components or sub-components, and/or additional components. For example, a system could include processing component 108, memory management component 102, memory protocol stack 104, rollback manager 404 and interface component 612, or a different combination of these and other components. Sub-components could also be implemented as components communicatively coupled to other components rather than included within parent components. Additionally, it should be noted that one or more components could be combined into a single component providing aggregate functionality. For instance, timing component 408 can include addressing component 410, or vice versa, to facilitate adjusting timing of Flash memory operations and configuring data pointers for data rollback by way of a single component. The components may also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

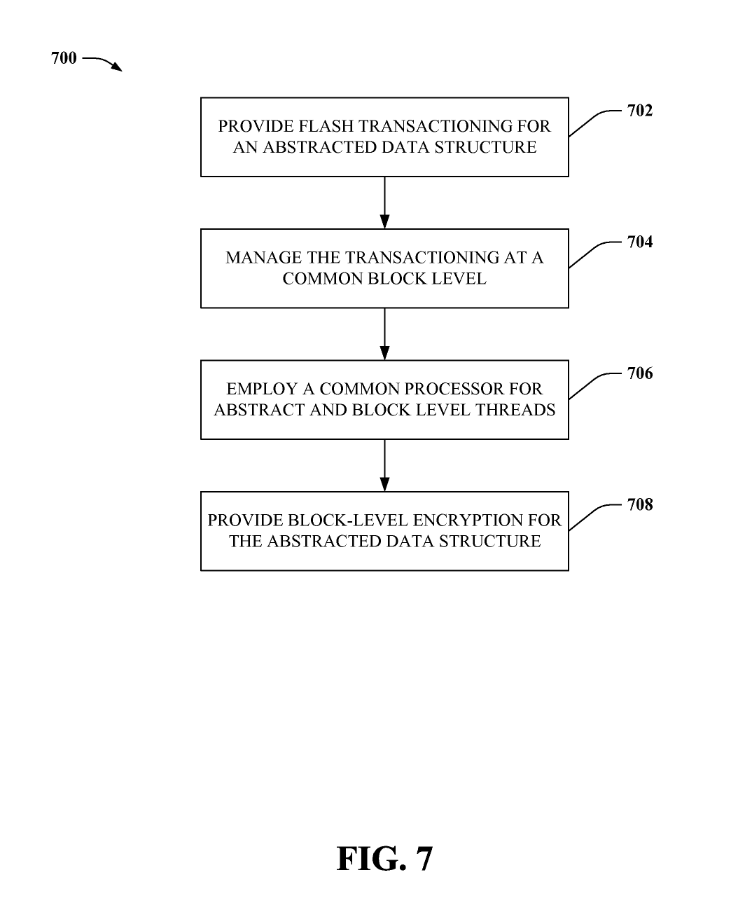

In view of the exemplary systems described supra, methodologies that may be implemented in accordance with the disclosed subject matter will be better appreciated with reference to the flow charts of FIGS. 7-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or media.

FIG. 7 depicts a flowchart of an example methodology 700 for bundling Flash related transactioning at a common protocol layer according to aspects of the disclosure. At 702, method 700 can provide Flash memory transactioning for a data structure. The data structure can be any suitable abstraction of raw Flash memory, such as arrangements of Flash cells and blocks of such cells on a Flash memory chip. More specifically, the data structure can incorporate higher levels of a Flash management protocol stack, such as an operating system layer, an application layer, and/or the like. It should further be appreciated that the transactioning can comprise error tracking functions, data indexing and content searching functions, data rollback functions, wear-leveling functions, data logging functions, or like Flash memory-related functions.

At 704, method 700 can implement management of raw Flash memory associated with one or more transactioning functions at a common block level of a Flash management protocol stack. By bundling the transactioning at a common layer, redundancy involved in repeated transactioning for multiple abstracted data structures (e.g., file system transactioning and database transaction) can be mitigated or avoided. Furthermore, by bundling the transactioning at a block level layer, access to raw Flash management can be provided in conjunction with the transactioning operations. For instance, read/write times can be adjusted, erase times altered and/or delayed, different algorithms for wear-leveling employed, content searching based on direct interaction with raw data can be conducted, and so on. Accordingly, increased efficiency and data throughput can also be provided.

At 706, method 700 can execute higher level data structure operations and block level Flash management operations at a common processing component. Thus, the data structure(s) and block level Flash management can be implemented at a CPU of a host computer or at an onboard chip of a Flash microcontroller. In the latter case, Flash memory can be provided that includes rich benefits of much more complex computer systems, such as SQL databases or the like. In the former case, process-heavy calculations are performed at a powerful CPU processor and relatively simple direct interactions (e.g., application of a voltage to a block of cells to simulate data storage, data erasure, and so on) can be left at the Flash device.

In addition to the foregoing, at 708, method 700 can implement block-level encryption for data stored in Flash memory in conjunction with block level Flash management of reference number 704. Thus, Flash security can be integrated with a standalone Flash device in at least one aspect. According to other aspects, increased reliability can be provided by avoiding or mitigating unauthorized access through complex abstracted application layers. Accordingly, increased flexibility, efficiency and reliability can be provided by methodology 900, as described herein.

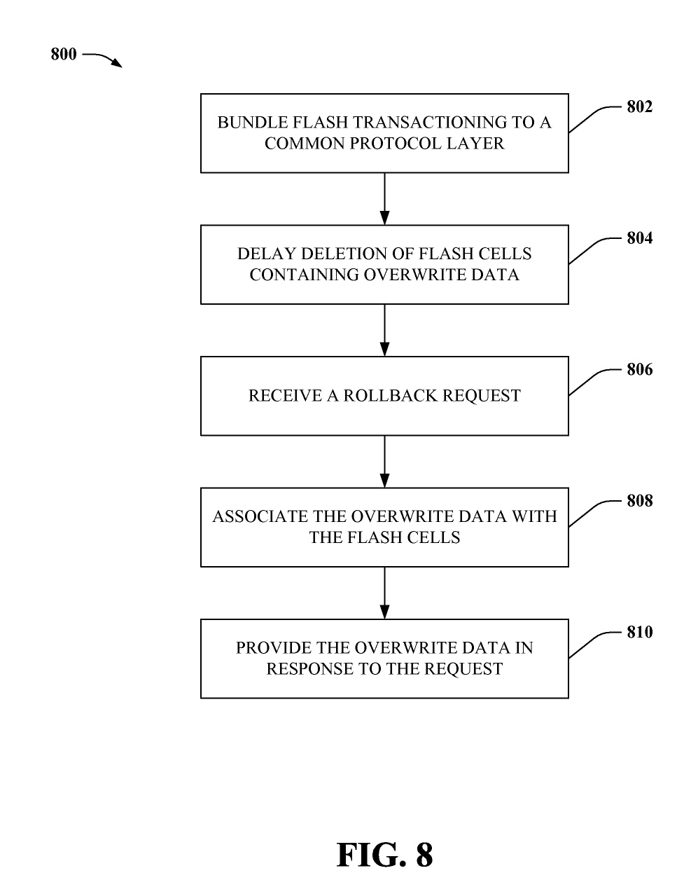

FIG. 8 illustrates a flowchart of a sample methodology 800 for providing improved rollback functionality for Flash memory. At 802, method 800 can bundle transactioning to a common protocol layer of a Flash management protocol stack. By bundling transactioning to the common protocol layer, redundant processing resulting from implementing such transactioning at multiple layers of the protocol stack for various abstracted systems can be mitigated or avoided. In some aspects, as described above, the common protocol layer can be a block level layer providing increased power and flexibility gained from close interface to low level memory (e.g., see FIG. 7, supra).

At 804, method 800 can delay deletion of raw Flash blocks containing data scheduled for overwrite, copying, or erasure. Typically, data management in Flash memory often involves copying data from one set of blocks to another to preserve the data. Because solid state memory like Flash cannot be overwritten as simply as other storage media (e.g., disc storage), the data is typically copied from storage blocks to intermediary blocks, the storage blocks are erased, and the data is copied back to the storage blocks from the intermediary blocks. Certain operations, like data rollback, can result in data scheduled for erasure being retrieved instead. Thus, method 800 can employ block level control over Flash memory operations to delay deletion of blocks of data. The delay can be based on an application command (e.g., calculated a likely time interval that a rollback request might occur) provided by an abstracted application, or one or more other threshold times.

At 806, method 800 can receive a rollback request. As indicated above, the rollback request can be provided by an abstracted application, such as a file system or database. The rollback request can involve retrieving data that was scheduled for deletion, and stored in temporary memory. At 808, method 800 can associate the overwrite data with the Flash cells. For instance, where the erasure of the storage blocks has not been accomplished at the time of receiving the rollback request. In other aspects, where the erasure had already been accomplished, the overwrite data can be associated with temporary memory, or with a new location, or the like. At 810, method 800 can read the Flash blocks associated with the overwrite data and provide such data in response to the rollback request. Accordingly, additional steps involved in copying data from temporary memory or from newly allocated memory to the storage blocks can be avoided in at least some instances. Instead, the data can be referenced at a current location and provided in response to the rollback request.

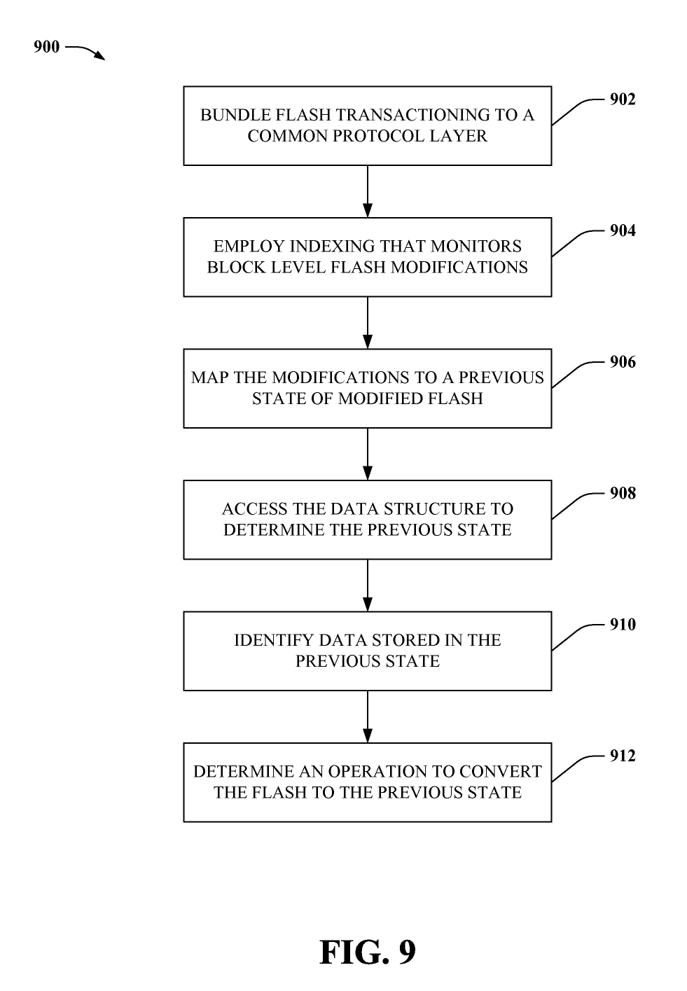

FIG. 9 depicts a flowchart of an example methodology 900 for monitoring block level Flash transactions in conjunction with an abstracted storage system. At 902, method 900 can bundle Flash transactioning to a common protocol layer of a Flash management protocol stack, as described herein. In at least some aspects of the subject disclosure, the common layer can be a block level layer of the protocol stack, providing a powerful interface to low level Flash for such transactioning.

At 904, method 900 can employ data indexing that monitors a block level modification to raw Flash memory. Further, at 906, method 900 can generate a data structure that maps the modification, or a Flash memory operation associated with the modification, to a previous state of the modified raw Flash memory or to data stored in such previous state. At 908, method 900 can access the data structure to determine the previous state or a current state of the modified raw Flash memory. Further, at 910, method 900 can reference the data structure to identify data stored in the previous state, e.g., in conjunction with a rollback operation. In accordance with at least some aspects, at 912, the data structure can be referenced to determine an operation suitable to convert the modified raw Flash memory from a current state to the previous state (e.g., a data pointer can be updated to reflect a new source of data).

In other aspects of the disclosure, indexing (e.g., at 904) can comprise tracking data, keywords of data (e.g., based on previous interactions with data, such as search queries) or the like to implement content filtering. The content filtering can be conducted in conjunction with raw Flash data, providing much greater efficiency as compared with content filtering bundled into complex abstracted representations of the underlying Flash. Accordingly, increased efficiency can be provided by method 900 in conjunction with various Flash memory-related applications.

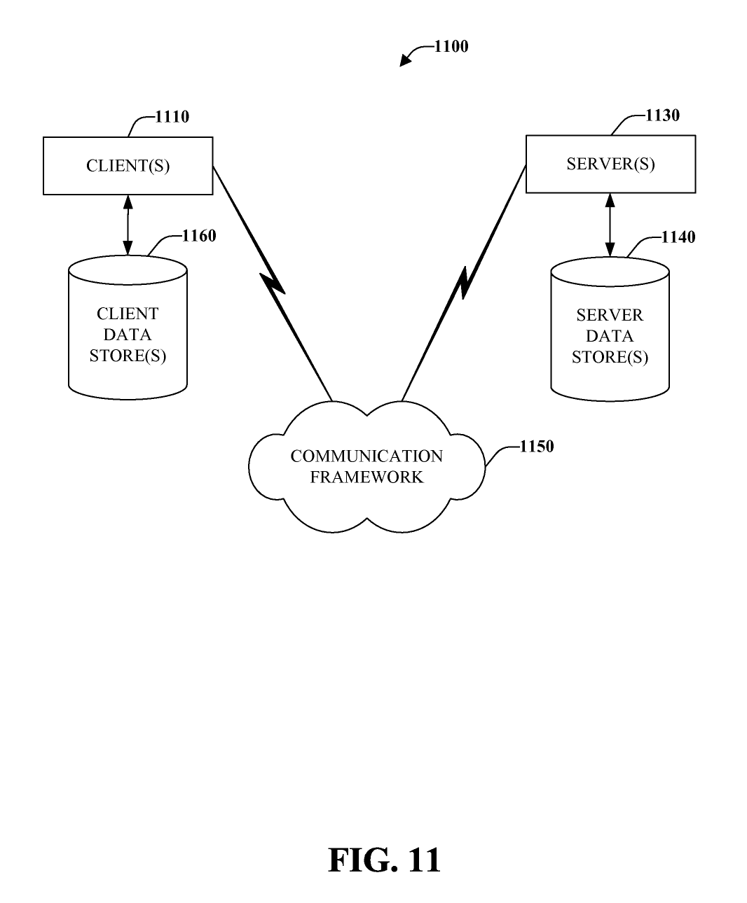

In order to provide additional context for various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules.

Generally, program modules include routines, programs, components, data structures, etc. that can perform particular tasks and/or implement particular abstract data types. Such tasks can include storing or retrieving data from memory, executing applications that store or consume stored memory, implementing data storage schemas, controlling and managing Flash memory, implementing storage transactioning, executing like Flash processes bundled at like protocol layers, and so on, as described herein. Further, relevant tasks can include utilizing a direct interface to raw Flash memory, providing control of lower level Flash operations to abstracted data storage systems, and efficiently and effectively implementing applications in conjunction with the improved Flash interface, as described herein. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices, described below.

With reference to FIG. 10, an exemplary environment 1010 for implementing various aspects disclosed herein includes a computer 1012 (e.g., desktop, laptop, server, hand held, programmable consumer or industrial electronics . . . ). The computer 1012 includes a processing unit 1014, a system memory 1016, and a system bus 1018. The system bus 1018 can couple system components including, but not limited to, the system memory 1016 to the processing unit 1014. The processing unit 1014 can be any of various microprocessors, such as dual microprocessors, quad microprocessors, and other multiprocessor architectures suitable for a computer environment 1010.

The system bus 1018 can be any of several types of suitable bus structure(s) including the memory bus or memory controller, a peripheral bus or external bus, and/or a local bus using any suitable variety of available bus architectures including, but not limited to, 10-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022 (including Flash memory, either local to the memory 1016 or coupled via the system bus 1018). The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or Flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example, disk storage 1024. Disk storage 1024 includes, but is not limited to, devices such as a magnetic disk drive, floppy disk drive, tape drive, Jaz drive, Zip drive, LS-100 drive, Flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in operating environment 1010. The software can include various rules for implementing aspects of the subject disclosure, such as adjusting memory read/write times, performing improved transactioning, interfacing segregated abstracted applications and low level Flash applications, and so on as described herein. Such software can include an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the present invention can be implemented with various operating systems or combinations of operating systems.

A user can enter commands or information into the computer 1012 through input device(s) 1036. Input devices 1036 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 can utilize some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like displays (e.g., flat panel and CRT), speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and can typically include many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems, power modems and DSL modems, ISDN adapters, and Ethernet cards or components.

FIG. 11 is a schematic block diagram of a sample-computing environment 1100 with which the present invention can interact. For instance, the environment 1100 can be suitable to provide a remote interface between one or more host devices and/or applications and a Flash memory module to facilitate remote data exchange between such device and module. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing the present invention, for example. One possible communication between a client 1110 and a server 1130 may be in the form of a data packet adapted to be transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1160 that can be employed to store information local to the client(s) 1110. Similarly, the server(s) 1130 are operatively connected to one or more server data store(s) 1140 that can be employed to store information local to the servers 1130.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A system that manages Flash memory, comprising:
a memory management component that employs a protocol stack having two or more layers executable at a common processor to manage Flash memory; and
a processing component that employs the common processor to execute a storage system configured for one or more abstracted layers of the protocol stack and a transactioning operation configured for a block layer of the protocol stack.

2. The system of claim 1, wherein at least one of:
the block layer is a lowest layer of the protocol stack and manages raw Flash; or
the one or more abstracted layers are higher layers of the protocol stack configured to exchange data or commands with the block layer to manage transactioning.

3. The system of claim 1, the transactioning operation is applied to the storage system and comprises at least one of data rollback, operation logging or error tracking, or a combination thereof.

4. The system of claim 1, further comprising a rollback manager that at least one of:
delays erasure of blocks of raw Flash scheduled for deletion;
resets a data pointer to the blocks scheduled for deletion if data stored by the blocks is rolled back; or
reads and provides the data to the storage system to facilitate rolling back the data.

5. The system of claim 1, the storage system comprises a data file system or a database.

6. The system of claim 1, further comprising a tracking component that creates an index of storage system operations associated with Flash memory at the block layer.

7. The system of claim 1, further comprising a security component that encrypts data placed into a block of the Flash memory prior to, or as the data is written.

8. The system of claim 1, the common processor comprises a host system processor or an onboard Flash microcontroller.

9. The system of claim 1, the two or more layers comprise at least a lowest layer for managing raw Flash and one or more higher layers for managing an abstracted representation of the raw Flash, including a file system or a database.

10. The system of claim 1, further comprising an interface component that translates activity associated with the storage system into commands or data that can be consumed by the transactioning operations at the block layer.

11. The system of claim 1, further comprising a management component that enables the storage system to modify operation of the raw Flash with respect to managing transactioning of the Flash memory.

12. A method of managing transactioning for Flash memory, comprising:
providing Flash memory transactioning for a data structure, the data structure incorporates higher levels of a Flash management protocol stack;
implementing raw Flash management associated with the transactioning at a common block level of the protocol stack; and
executing higher level data structure operations and block level Flash management operations at a common processing component.

13. The method of claim 12, the Flash memory transactioning comprises a data rollback that further comprises:
delaying deletion of raw Flash blocks containing data scheduled for Flash overwrite;
receiving a request to rollback the overwrite data;
associating the overwrite data with the raw Flash blocks; and
reading the raw Flash blocks and providing the overwrite data in response to the request.

14. The method of claim 12, the Flash memory transactioning comprises data indexing that further comprises:
monitoring a block level modification to the raw Flash memory;
generating a data structure that maps the modification, or a Flash memory operation associated with the modification, to a previous state of the modified raw Flash memory or to data stored in the previous state; and
accessing the data structure to determine the previous state or a current state of the modified raw Flash memory.

15. The method of claim 14, further comprising at least one of:
referencing the data structure to identify the data stored in the previous state; or
referencing the data structure to determine an operation suitable to convert the modified raw Flash memory from a current state to the previous state.

16. The method of claim 12, the Flash memory transactioning employs a Flash memory wear leveling algorithm, a transaction logging algorithm, an error checking algorithm, or a data rollback algorithm, or a combination thereof, for managing Flash memory.

17. The method of claim 12, further comprising employing either a host device processor or an onboard Flash microcontroller as the common processing component.

18. The method of claim 12, further comprising employing a database application or a file system application as the data structure.

19. The method of claim 12, further comprising employing block level Flash management for encrypting data as the data is written into blocks of Flash memory.

20. A system that manages Flash memory, comprising:
a memory interface that employs a protocol stack having two or more layers to manage Flash memory;
an application component that implements a storage-related system application on at least one abstraction layer of the two or more layers;
a Flash management component that implements a transactioning operation for the system application at a common block layer of the two or more layers;
an abstraction interface that translates transactioning commands or data required by the system application between the abstraction layer(s) and the block layer; and
an integrated processing component that executes Flash transactioning operations at the block layer and system application operations at the abstraction layer(s) on a common processing device.
